(19) United States
(12) Patent Application Publication
(10) Pub. No.: US 2012/0228282 A1
(43) Pub. Date: Sep. 13, 2012

(54) Cooktop

(75) Inventors: Laura J. Schroeder, Southboro, MA (US); Raymond O. England, Harrisville, RI (US); David W. Beverly, Lunenburg, MA (US); Alfred G. Giombetti, Ashland, MA (US)

(73) Assignee: Bose Corporation, Framingham, MA (US)

(21) Appl. No.: 13/045,093

(22) Filed: Mar. 10, 2011

(51) Int. Cl. H05B 3/68

(52) U.S. Cl. 219/445.1

(57) ABSTRACT

An apparatus for a cooking system with a number of electrically-operated heating elements that each define a center, and a number of heating element power control circuits that each control power flow to a respective one of the heating elements. There is a cooktop surface member located above the heating elements and defining a top surface and a front edge. There are also a number of user interface elements visible from above the top surface of the cooktop surface member and spaced from the heating elements. One of each of the user interface elements is operatively associated with a respective one of the heating elements and used to control the heating element power control circuit for such heating element. The heating elements and the user interface elements are arranged such that for each heating element a line on the top surface of the cooktop surface member that contains the normal projection of the center of the heating element onto the top surface of the cooktop surface member and is normal to the front edge of the cooktop surface member, intersects the user interface element that is associated with the heating element.

### FIELD

This disclosure relates to a cooktop with electrically-operated heating elements.

### BACKGROUND

Electric cooktops of the type in which the heating elements are located under the cooktop surface typically have a flat glass-ceramic cooktop surface. The electrically-driven induction or radiant heating elements are located below and typically spaced from the cooktop surface. Cookware is placed on the cooktop surface directly above the heating elements. The user needs to know the locations of the heating elements so that the cookware can be placed directly above a heating element. The heating element location is typically indicated with graphics located directly above the element that are visible from above the top surface of the cooktop.

Such cooktops also include user interface elements that are manipulated by the user to control power flow to the heating elements. The user interface elements are also visible from above the top surface of the cooktop. The user interface elements can be physical elements such as knobs or sliders. Alternatively they can be graphics or other indications to the user of the locations at which the cooktop surface is touched to properly activate non-contact control devices that are operable through the cooktop surface. Examples of non-contact control devices include capacitive sensors located below the cooktop surface. If physical user interface elements are used they may penetrate the cooktop surface, or they may be coupled through the cooktop surface with a non-mechanical coupling such as a magnetic coupling. In many cases non-penetrating user interface elements are preferred so that the cooktop surface is easier to clean.

To properly use the cooktop, the user must associate a user interface element with a heating element. Many times the relationship is indicated by the use of words such as “front”, “rear”, “left” and “right” adjacent to the user interface element. This arrangement causes the user to have to consider the relationship between the user interface element and the heating element before operation.

### SUMMARY

In general, one aspect of the disclosure features an apparatus for a cooking system that comprises a plurality of electrically-operated heating elements that each define a center, and a plurality of heating element power control circuits that each control power flow to a respective one of the heating elements. The apparatus has a cooktop surface member located above the heating elements and defining a top surface and a front edge, and a plurality of user interface elements visible from above the top surface of the cooktop surface member and spaced from the heating elements, one of each of the user interface elements operatively associated with a respective one of the heating elements and used to control the heating element power control circuit for such heating element. The heating elements and the user interface elements are arranged such that for each heating element a line on the top surface of the cooktop surface member that contains the normal projection of the center of the heating element onto the top surface of the cooktop surface member, and is normal to the front edge of the cooktop surface member, intersects the user interface element that is associated with the heating element.

Various implementations of the disclosure may include one or more of the following features. The user interface elements may each define a center, and each line may pass through the center of its associated user interface element. In one case, no line intersects any other line. The apparatus may further comprise an equal plurality of graphics visible from above the top surface of the cooktop surface member, each graphic defining a center and indicating the location of one of the heating elements. These graphics may be generally circular. The user interface elements may be generally linear. The user interface elements may be located proximate the front edge of the cooktop surface member. The front edge of the cooktop surface member may be generally straight and the user interface elements may be generally parallel to the front edge. The generally circular graphics and their associated generally linear user interface elements may be further arranged such that each of the line bisects a circular graphic and bisects its associated generally linear user interface element. The lines may be essentially perpendicular to the front edge of the cooktop surface member. All of the graphics may be the same as one another, and all of the user interface elements may be the same as one another. Each of the user interface elements may define a slider bar that is used to select the power level of the heating element with which it is associated. The heating elements may be inductive elements.

In general, another aspect of the disclosure features an apparatus for a cooking system that comprises a plurality of electrically-operated heating elements that each define a generally circular periphery, and a plurality of heating element power control circuits that each control power flow to a respective one of the heating elements. The apparatus has a cooktop surface member located above the heating elements and defining a top surface and a front edge, and a plurality of user interface elements visible from above the top surface of the cooktop surface member and spaced from the heating elements, one of each of the user interface elements operatively associated with a respective one of the heating elements and used to control the heating element power control circuit for such heating element. The heating elements and the user interface elements are arranged such that for each heating element, two planes that are tangent to the periphery of the heating element and are normal to both the top surface and the front edge of the cooktop surface member fully encompass and do not intersect the user interface element associated with such heating element.

Various implementations of the disclosure may include one or more of the following features. The apparatus may further comprise an equal plurality of graphics visible from above the top surface of the cooktop surface member, each graphic indicating the location of one of the heating elements. The graphics may be generally circular. The user interface elements may be generally linear. The user interface elements may be located proximate the front edge of the cooktop surface member. The front edge of the cooktop surface member may be generally straight and the user interface elements may be generally parallel to the front edge. The generally circular graphics and their associated generally linear user interface elements may be further arranged such that straight line segments that run from the center of each circular graphic to the front edge of the cooktop surface member and are normal to the front edge of the cooktop surface member, each bisect a generally linear user interface element. The heating elements may be inductive elements.

In general, another aspect of the disclosure features an apparatus for a cooking system that comprises a plurality of electrically-operated heating elements that each define a center, and a plurality of heating element power control circuits that each control power flow to one of the heating elements. The apparatus has a cooktop surface member located above the heating elements and defining a top surface, a front edge, a rear edge, and a bisecting line that is normal to the front edge and the rear edge and divides the cooktop surface member into generally equally sized left and right halves. There are also a plurality of graphics visible from above the top surface of the cooktop surface member, each graphic defining a center and indicating the location of one of the heating elements, and a plurality of user interface elements that each define a center, are visible from above the top surface of the cooktop surface member, and are spaced from the heating elements, one of each of the user interface elements operatively associated with a respective one of the heating elements and used to control the heating element power control circuit for such heating element. The graphics and the user interface elements are arranged such that the angles between straight line segments that run from the center of each graphic to the center of its associated user interface element are symmetric with respect to the cooktop surface member bisecting line.

Various implementations of the disclosure may include one or more of the following features. The graphics and the user interface elements may be arranged such that the angles between adjacent straight line segments are essentially equal. The graphics may be generally circular. The user interface elements may be generally linear. The user interface elements may be located proximate the front edge of the cooktop surface member. The front edge of the cooktop surface member may be generally straight and the user interface elements may be generally parallel to the front edge. The heating elements may be inductive elements.

In general, another aspect of the disclosure features an apparatus for a cooking system that comprises a plurality of electrically-operated heating elements that each define a center, and a plurality of heating element power control circuits that each control power flow to one of the heating elements. The apparatus has a cooktop surface member located above the heating elements and defining a top surface and a front edge and a plurality of user interface elements that each define a center, are visible from above the top surface of the cooktop surface member, and are spaced from the heating elements, one of each of the user interface elements operatively associated with a respective one of the heating elements and used to control the heating element power control circuit for such heating element. The heating elements and the user interface elements are arranged such that lines on the top surface of the cooktop surface member that contain both the normal projection of the center of each heating element onto the top surface of the cooktop surface member and the center of its associated user interface element, are all radial with respect to a common point.

Various implementations of the disclosure may include one or more of the following features. The common point may be located on the surface of the cooktop surface member. The common point may be located along the front edge of the cooktop surface member. The common point may be located at the center of the front edge of the cooktop surface member. The apparatus may further comprise an equal plurality of graphics visible from above the top surface of the cooktop surface member, each graphic indicating the location of one of the heating elements. The graphics may be generally circular. The user interface elements may be generally linear. The heating elements may be inductive elements.

### BRIEF DESCRIPTION OF THE DRAWINGS

FIG. 1 is a top view of a cooktop surface member.

FIG. 2 is a partial simplified schematic side view of a cooking system apparatus that includes the cooktop surface member of FIG. 1.

FIG. 3 is a top view of a portion of another cooktop surface member.

FIG. 4 is a top view of a portion of another cooktop surface member.

FIG. 5 is a top view of another cooktop surface member.

FIG. 6 is a top view of a cooking system apparatus.

### DETAILED DESCRIPTION

It is desirable to visually associate the user interface elements that allow the user to control the cooktop heating element power control circuits with the respective heating element that is controlled by such control circuit, as well as to associate the user interface elements with the visible cooktop surface graphics that indicate the location of the heating element. Such intuitive visual mapping of the user interface elements to the heating elements allows the user to immediately associate the controls with the heating element without having to read directions or even stop to consider which user interface element is associated with which heating element.

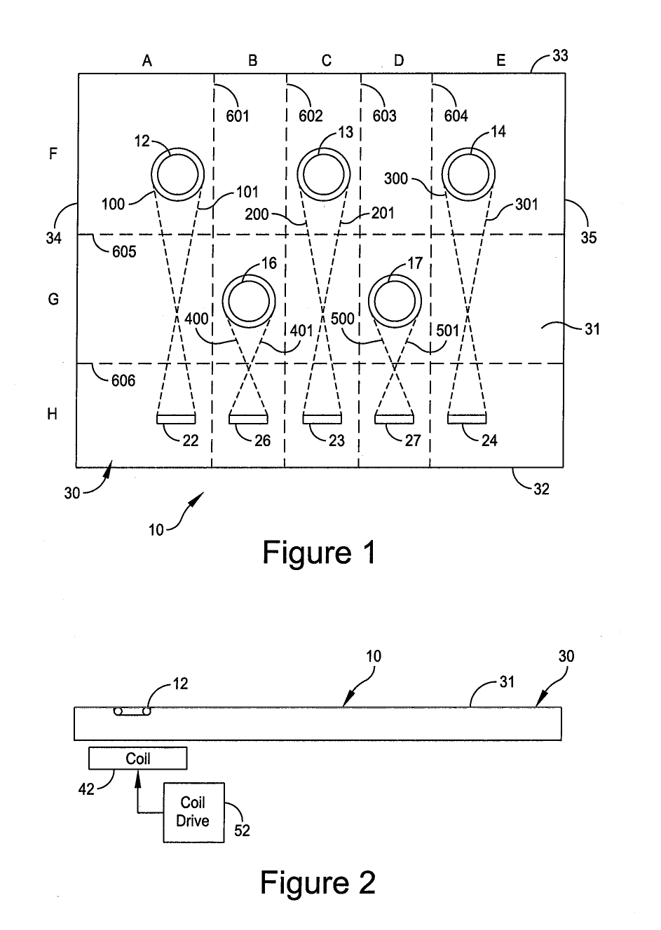

Referring to FIGS. 1 and 2, cooking system apparatus 10 comprises upper flat panel or cooktop surface member 30, which is typically but not necessarily a flat glass-ceramic panel of a type known in the art. Member 30 can alternatively be made of less traditional cooktop materials such as solid surface countertop materials, wood, tile, laminate countertop materials, vinyl, glass other than ceramic glass, plastic, etc. Member 30 defines front edge 32, rear edge 33, left and right edges 34 and 35, respectively, and top surface 31. Member 30 is shown as rectangular which is a common shape but is not necessary; the member can have other shapes such as square or a more arbitrary rectilinear or non-rectilinear shape. Member 30 in this instance overlies five electrically-operated heating elements, although the cooktop may comprise fewer or more heating elements. Only one such heating element 42, which is an induction coil for an induction cooking system, is shown in FIG. 2. Coil 42 is energized by coil drive or heating element power control circuit 52. There are user-operable devices that allow the user to control the power provided from the heating element power control circuits to the coils. For a radiant cooktop, induction coil 42 would be replaced with a resistive heating element supplied with power from an appropriate user-controlled power source.

Directly above each heating element is a graphic visible from above top surface 31. The graphics thus visually indicate to the user the locations of the heating elements. The graphics can be of a desired size and shape. The graphics may be smaller than, the same size as or larger than the heating elements. The graphics may be the same shape as or a different shape than the heating elements. Graphics 12, 13, 14, 16 and 17 are annular and smaller than the heating elements, but they could be another size, shape or arrangement that creates visual cues of the locations of the heating elements. Desirably but not necessarily, when the heating elements are generally circular the centers of the heating elements and the centers of their associated graphics are generally or essentially coincident, so that the graphic is centered on the heat source. One advantage of generally circular annular graphics is that most cookware defines a circular bottom, and it is visually easier to align circular cookware with the center of a circular graphic. This helps the user to align the cookware with the heating element, to improve cooking efficiency and results.

The graphics could have a different size, shape or arrangement, almost without limitation. For example, the circular annular shape could instead be square or rectangular or oval, or look more like a target or, for example, comprise any number of variations of one or more graphics that are or have been associated with a cooktop heating element. Additional examples of visible displays for displaying cooking-related information that could accomplish the graphics as disclosed herein may be found in U.S. Pat. No. 7,554,060, the disclosure of which is incorporated herein by reference.

The graphics can be created in a desired fashion. For example they may comprise material applied to or removed from the top surface of the cooktop surface member, or the bottom surface of the cooktop surface member (presuming that the cooktop surface member is transparent or translucent), or embedded within the cooktop surface member as indicated with graphic 12. The graphics may also be accomplished with lighted or unlighted elements.

In one non-limiting example, the multiple (typically three to six) heating elements are identical, as are the associated heating element indicating graphics. For an induction cooktop the induction coils may be nominally about seven inches in diameter, and the annular graphics (such as those shown in FIG. 1) may be about fourteen inches in diameter.

Cooktop 10 also comprises visible user interface elements. These user interface elements are visible from above top surface 31 of cooktop surface member 30. User interface elements 22, 26, 23, 27, and 24 are associated with graphics 12, 16, 13, 17 and 14, respectively, with one user interface element associated with a separate one of the heating elements. The user interface elements can be physically operable elements such as knobs that are turned, or other projections that are moved such as sliders. Alternatively, the user interface elements may be graphics visible from above the top surface 31 of cooktop surface member 30 that indicate to the user the location of the control for the respective heating element. In this embodiment, user interface elements 22, 26, 23, 27 and 24 can be graphics that visually represent or emulate a slider-type control, for example. The graphics that represent the control (i.e., the user interface elements) in this case are generally linear, and are essentially parallel to the straight front edge 32 of cooktop surface member 30. However, the graphics need not be linear and need not be parallel to any edge of member 30.

In an embodiment, the graphics that indicate the locations of the heating elements, and the user interface elements that are associated with such graphics, are arranged such that the graphics and respective user interface elements are directly aligned with one another along the line of sight of a user standing in front of the cooktop. There is thus an immediate intuitive visual mapping of the user interface element to the controlled heating element. This arrangement allows the user to properly operate the cooktop without having to read instructions or even stop to consider which heating element is being controlled. These features accomplish ease of use and also increase safety, as it less likely that an incorrect or undesired heating element will be mistakenly operated.

The spatial and visual correlation between the user interface elements and the heating elements can be accomplished in an embodiment by arranging the heating element location indicating graphics and the respective user interface elements such that no straight line segment that interconnects any part of a graphic that indicates the location of a heating element with any part of its associated user interface element intersects any other straight line segment that interconnects any part of a different graphic that indicates the location of a different heating element with any part of its associated user interface element. One non-limiting example of this arrangement is depicted in FIG. 1. For example, heating element location indicating annular graphic 12 is aligned directly in line with and behind user interface element 22 that is proximate and generally parallel to front edge 32 of cooktop member 30; user interface element 22 is for the user-operable power control circuit that controls power flow to the heating element located directly under graphic 12. Straight line segments 100 and 101 are examples of all possible straight line segments that interconnect any part of graphic 12 with any part of user interface element 22; obviously there would be many more such line segments than those shown in FIG. 1.

The other four sets of the heating element location indicating graphics, and their associated user interface elements, are depicted in FIG. 1. User interface element 26 is associated with graphic 16. User interface element 23 is associated with graphic 13. User interface element 27 is associated with graphic 17. User interface element 24 is associated with graphic 14. Straight line segments 400 and 401 are examples of interconnecting straight line segments for graphic 16 and its associated user interface element 26. Straight line segments 200 and 201 are examples of the same for graphic 13 and its associated user interface element 23. Straight line segments 500 and 501 are examples of the same for graphic 17 and its associated user interface element 27. Straight line segments 300 and 301 are examples of the same for graphic 14 and its associated user interface element 24. As can be seen and as is apparent, none of the straight line segments for any of the sets of associated graphics and user interface elements intersect any other straight line segment that interconnects any other graphic with its associated user interface element. This is one manner of defining the spatial and thus visual relationship between a user interface element and its associated heating element location indicating graphic, and thus between the user interface element and the associated heating element that is controlled via manipulation of such user interface element.

Another way to define the visual correlation between the graphics and the associated user interface elements depicted in FIG. 1 (or the heating elements and their associated user interface elements) is to consider that the arrangement of graphics 12, 13, 14, 16 and 17 (and/or the heating elements associated with and located directly under the graphics) are such that they are arranged in two rows relative to front edge 32, labeled rows F and G. Row F is delineated by rear edge 33 of cooktop surface member 30 and imaginary straight line 605 that is parallel to cooktop surface member edges 32 and 33. Row G is delineated by imaginary straight line 606 and imaginary straight line 605, both of which are parallel to edges 32 and 33. The graphics and/or the heating elements are further arranged in a number of separate columns equal to the number of graphics. In this example there are five graphics and/or heating elements that are arranged in five separate columns, labeled A-E, and delineated by side edges 34 and 35 of member 30 and imaginary straight lines 601-604 that are parallel to sides 34 and 35 and perpendicular to edges 32 and 33, as shown in FIG. 1. In an embodiment, the user interface element(s) that are associated with a particular graphic, and thus with a particular heating element represented by the graphic, are also located in the same columns with such graphics and/or heating elements. Thus, user interface element 22 is located in column A, user interface element 26 is located in column B, user interface element 23 is located in column C, user interface element 27 is located in column D, and user interface element 24 is located in column E.

The locations in separate columns means that none of the graphics and/or heating elements overlap with respect to front edge 32. In other words, no graphic and/or heating element is located directly in front of or directly behind another graphic and/or heating element. Thus to a user standing in front of front edge 32, there is a natural visual alignment between the user interface element and the heating element controlled thereby. If the user is standing directly in front of a user interface element (proximate front edge 32), the heating element location indicating graphic (and thus its controlled heating element) is directly behind the user interface element. In this embodiment, the user interface elements are also linearly arranged proximate and parallel to front edge 32, and located in separate third row H defined by front edge 32 and imaginary line 606.

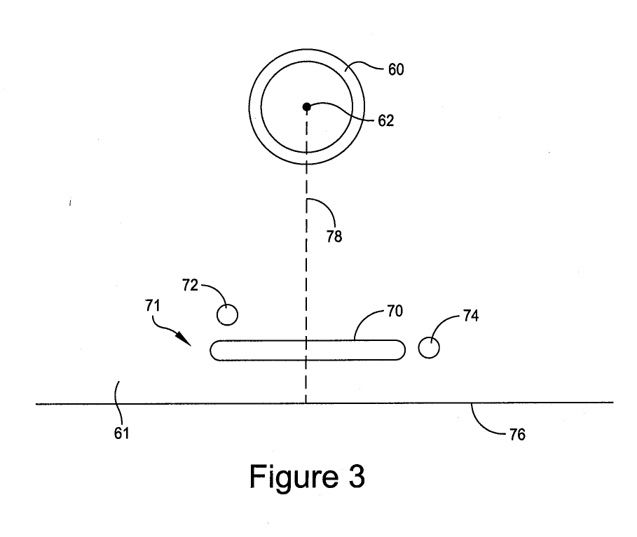

FIG. 3 is a partial, close-up view of a different cooktop surface member 61 that defines straight or generally straight front edge 76. Graphic 60 is visible from above the top surface of member 61 and is indicative of the location of an induction heating element (not shown), located directly below graphic 60. In this case, graphic 60 is an annular circular graphic centered about center 62 which is also preferably but not necessarily coincident with the center of the generally circular induction heating element, not shown. Generally linear heating element user interface element 71 in this case comprises a two-dimensional graphic 70 that mimics a slider and indicates locations at which the user can touch the cooktop to engage a capacitive control element located below the cooktop directly below graphic 70. Circular graphics, lights or other visual indicators 72 and 74 may be used to indicate other information to the user, for example one of these indicators may be indicative of whether the heating element is on or off and the other may be indicative of whether full power has been reached. The physical arrangement between the heating element location indicating graphic 60 and the user interface element graphic 70 is such that a single straight line segment 78 that lies on the top surface of the cooktop surface member bisects both graphic 60 and graphic 70. Segment 78 may also be essentially normal to member 61 front edge 76. This arrangement causes graphic 60 to be located directly behind and in line of sight with graphic 70.

Applying this same reasoning to FIG. 1, a straight line segment that bisects each graphic and its associated user interface element would also be essentially perpendicular to straight front edge 32. Also, each such straight line segment would be essentially parallel to the other straight line segments that bisect the other graphics and their associated user interface elements. Also, since the heating elements are located directly below the graphics, the straight line segments that bisect a graphic and its associated user interface element and are normal to the front edge of the cooktop surface member also contain the normal projection of the center of the heating element onto the top surface of the cooktop surface member and intersect the user interface element that is associated with the heating element. This physical arrangement maintains the same spatial relationship between each of the user interface elements and its associated heating element and the location-indicating graphic therefore. The user will thus easily and intuitively understand which user interface for the heating element power control circuit is associated with which heating element.

Cooktop surface members need not be rectangular and need not have a straight front edge. If the front edge were curvilinear or had a different shape, the described relationships between the user interface elements and the heating element as well as the heating element indicating graphics can remain the same. For example, if front edge 32 of member 30 was wavy or otherwise curved rather than straight, there would be no effect on the spatial relationships between the graphics and their associated user interface elements.

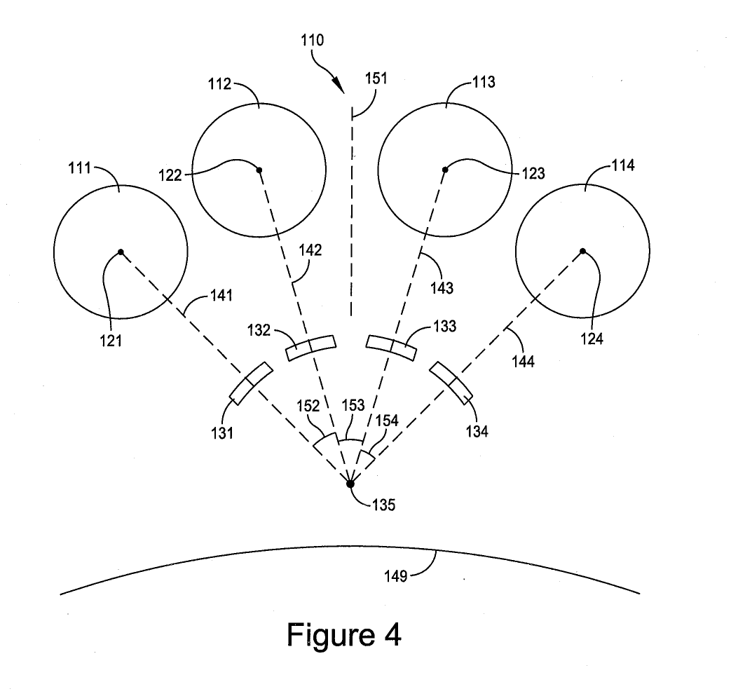

There are many other possible alternative arrangements of the heating element location indicating graphics and/or the heating elements, and the user interface elements, that accomplish one or more of the stated physical or visual interrelationships. One non-limiting example of such an arrangement 110 is depicted in FIG. 4. Curved cooktop panel member front edge 149 is indicated. Four circular heating element location indicating graphics 111-114 (and thus the heating elements located directly below the graphics) are arranged relative to their associated user interface elements 131-134 such that straight line segments that are on the top surface of the cooktop surface member and bisect a graphic and its associated user interface element are located along rays from common center 135. Point 135 can be located on the cooktop surface member or not.

Thus, line segment (ray) 141 that runs from center 121 of circle 111 to point 135 bisects user interface element 131. Similarly, line segment (ray) 142 that connects center 122 of circle 112 to point 135 bisects user interface element 132, line segment (ray) 143 that connects center 123 of circle 113 to point 135 bisects user interface element 133, and line segment (ray) 144 that connects center 124 of circle 114 to point 135 bisects user interface element 134. None of the four line segments intersect in the areas between the graphics (and the heating elements) and their associated user interface elements. Also, any straight line segment connecting any part of a graphic to any part of its associated user interface element will not intersect any other straight line segment connecting any part of another graphic to any part of its associated user interface element.

Another aspect of a spatial relationship between the heating element and its graphic, and the user interface element associated with them, is illustrated in FIG. 4. The graphics and the user interface elements are arranged such that the angles between straight line segments that run from the center of each graphic to the center of its associated user interface element are symmetric with respect to a cooktop surface member bisecting line that is normal to the front and rear edges of the cooktop surface member and divides the cooktop surface member into generally equally sized left and right halves. In this non-limiting example, straight line segments 141-144 are symmetric with respect to cooktop surface member bisecting line 151. The symmetry can be further enhanced if the angles between adjacent straight line segments are essentially equal. Thus for the arrangement depicted in FIG. 4, angle 152 between lines 141 and 142, angle 153 between lines 142 and 143, and angle 154 between lines 143 and 144, are all equal. As another example, in the case of the arrangement shown in FIG. 1 where the user interface elements are directly in front of the associated graphic and heating element, the angle between straight line segments than run from the center of a graphic to the center of its associated user interface element are all 180 degrees.

FIG. 4 also illustrates a cooktop with four heating elements. The arrangements herein can be applied to a cooktop with two or more heating elements. The arrangements can also be applied to cooktops in which the heating element location is indicated with a graphic of arbitrary shape and/or size.

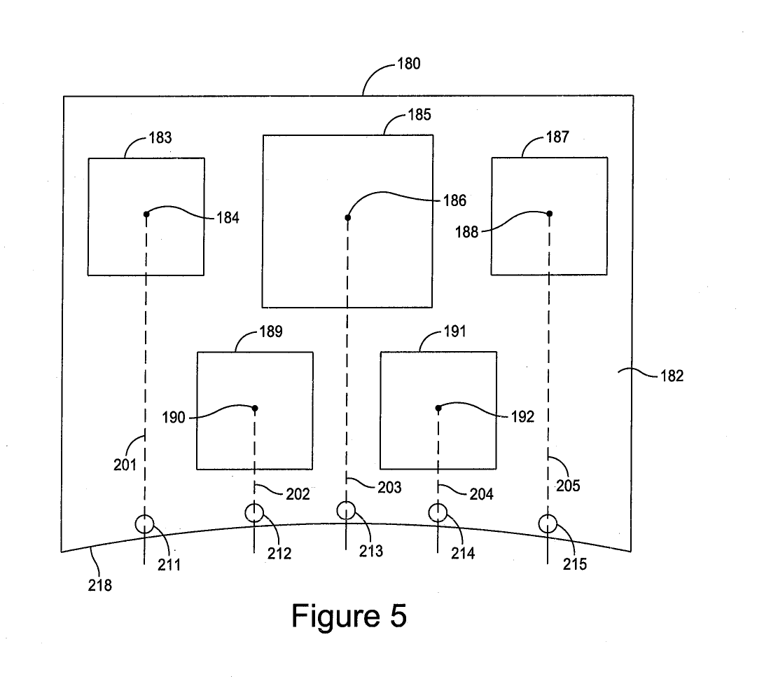

FIG. 5 depicts other graphics and user interface elements and their arrangements on the cooktop surface member. Cooktop surface member 180 defines top surface 182. Heating element location indicating graphics 183, 185, 187, 189 and 191 are rectangles visible from above surface 182, and define centers 184, 186, 188, 190 and 192, respectively. If the graphics and/or the associated heating elements were such so that they did not have an exact geometric center (as opposed to a shape that does have an exact geometric center as does a circle or a rectangle, for example), the “center” for purposes of the alignment referred to herein could be considered to be a point or area within the graphic and/or the heating element that was generally centric to its shape, such as the centroid, or an area that is generally central to the particular shape. User interface elements 211-215, which in this case are knobs that are turned by the user, control the power to the heating elements associated with graphics 183, 185, 187, 189 and 191, respectively. Imaginary straight line segments 201-205 that contain the centers of graphics 183, 185, 187, 189 and 191 and the centers of user interface elements 211-215, respectively, are each normal to curved cooktop surface member front edge 218. The line segments would also be normal to a straight front edge. The direct visual correlation between a user interface element and a graphic (and thus a heating element) is present even though the graphics overlap with respect to front edge 218; in other words the graphics are not entirely located in five separate columns as is the case with the cooktop surface member shown in FIG. 1, for example.

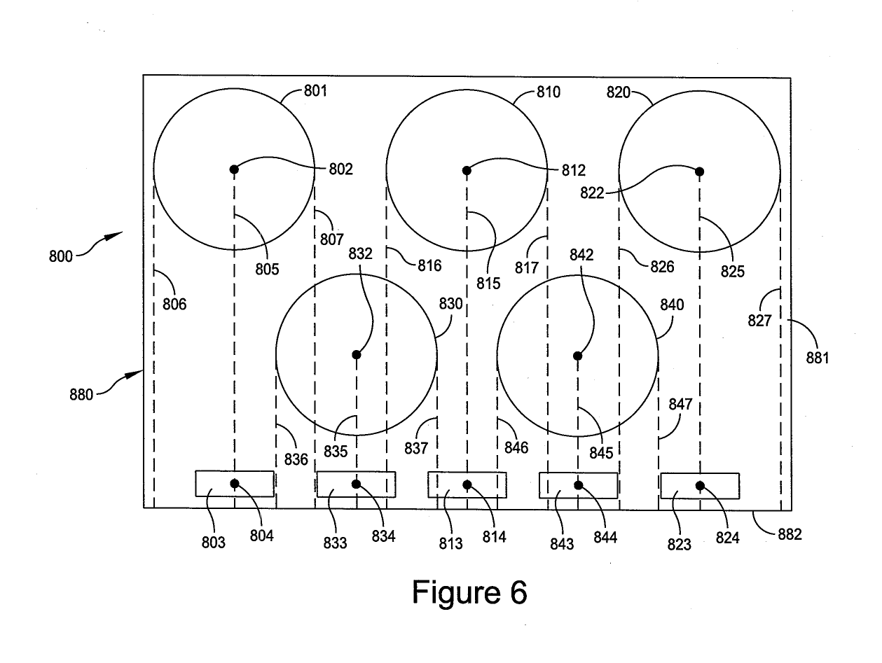

FIG. 6 shows cooking system apparatus 800 which includes cooktop surface member 880 that has a flat or generally flat top surface 881, and front edge 882. Generally circular heating elements 801, 810, 820, 830 and 840 are located underneath cooktop surface member 880. Heating elements 801, 810, 820, 830 and 840 define centers 802, 812, 822, 832 and 842, respectively. User interface elements 803, 813, 823, 833 and 843 are operatively associated with heating elements 801, 810, 820, 830 and 840, respectively, and are manipulated by a user to control the power control circuit (not shown) for the heating element. The heating elements and the user interface elements are arranged such that a plurality of lines on the top surface of the cooktop surface member and that contain the normal projection of the center of each heating element onto the top surface of the cooktop surface member and are normal to the front edge of the cooktop surface member, intersect the user interface element that is associated with the respective heating element. So, line 805 (which is normal to front edge 882) runs from projected heating element center 802 and intersects user interface element 803. In this non-limiting example, line 805 bisects user interface element 803, thus it intersects center 804 of user interface element 803. Also, line 815 (which is normal to front edge 882) runs from projected heating element center 812 and intersects user interface element 813. In this non-limiting example, line 815 bisects user interface element 813, thus it intersects center 814 of user interface element 813. Also, line 825 (which is normal to front edge 882) runs from projected heating element center 822 and intersects user interface element 823. In this non-limiting example, line 825 bisects user interface element 823, thus it intersects center 824 of user interface element 823. Also, line 835 (which is normal to front edge 882) runs from projected heating element center 832 and intersects user interface element 833. In this non-limiting example, line 835 bisects user interface element 833, thus it intersects center 834 of user interface element 833. Also, line 845 (which is normal to front edge 882) runs from projected heating element center 842 and intersects user interface element 843. In this non-limiting example, line 845 bisects user interface element 843, thus it intersects center 844 of user interface element 843. A result is that each heating element, and the graphic associated with and located on the cooktop surface member directly above the heating element, is located directly behind the user interface element that is associated with such heating element.

Another spatial relationship between the heating elements and associated location-indicating graphics, and the user interface element associated with such heating element and graphic, is also illustrated in FIG. 6. Each user interface element in this non-limiting example has a length in the direction parallel to front edge 882 of cooktop surface member 880 that is no greater than the width of the heating element in this same direction. Another way to express this relationship for generally circular heating elements and a user interface element located directly in front of the heating element, as depicted in FIG. 6, is that two planes that are tangent to the periphery of the heating element, and are normal to both the top surface and the front edge of the cooktop surface member, fully encompass and do not intersect the user interface element associated with such heating element. Thus, planes 806 and 807 that are tangent to the periphery of heating element 801 and are normal to top surface 881 and front edge 882 of cooktop surface member 880 fully encompass and do not intersect user interface element 803. Also, planes 816 and 817 that are tangent to the periphery of heating element 810 and are normal to top surface 881 and front edge 882 of cooktop surface member 880 fully encompass and do not intersect user interface element 813. Also, planes 826 and 827 that are tangent to the periphery of heating element 820 and are normal to top surface 881 and front edge 882 of cooktop surface member 880 fully encompass and do not intersect user interface element 823. Also, planes 836 and 837 that are tangent to the periphery of heating element 830 and are normal to top surface 881 and front edge 882 of cooktop surface member 880 fully encompass and do not intersect user interface element 833. Also, planes 846 and 847 that are tangent to the periphery of heating element 840 and are normal to top surface 881 and front edge 882 of cooktop surface member 880 fully encompass and do not intersect user interface element 843.

A number of embodiments and options have been described herein. Modifications may be made without departing from the spirit and scope of the invention. Accordingly, other embodiments are within the claims.

What is claimed is:

1. An apparatus for a cooking system that comprises a plurality of electrically-operated heating elements that each define a center, and a plurality of heating element power control circuits that each control power flow to a respective one of the heating elements, the apparatus comprising:
a cooktop surface member located above the heating elements and defining a top surface and a front edge; and
a plurality of user interface elements visible from above the top surface of the cooktop surface member and spaced from the heating elements, one of each of the user interface elements operatively associated with a respective one of the heating elements and used to control the heating element power control circuit for such heating element;
wherein the heating elements and the user interface elements are arranged such that for each heating element a line on the top surface of the cooktop surface member that contains the normal projection of the center of the heating element onto the top surface of the cooktop surface member, and is normal to the front edge of the cooktop surface member, intersects the user interface element that is associated with the heating element.

2. The apparatus of claim 1 wherein the user interface elements each define a center, and wherein each line passes through the center of its associated user interface element.

3. The apparatus of claim 1 wherein no line intersects any other line.

4. The apparatus of claim 1 further comprising an equal plurality of graphics visible from above the top surface of the cooktop surface member, each graphic defining a center and indicating the location of one of the heating elements.

5. The apparatus of claim 4 wherein the graphics are generally circular.

6. The apparatus of claim 5 wherein the user interface elements are generally linear.

7. The apparatus of claim 6 wherein the user interface elements are located proximate the front edge of the cooktop surface member.

8. The apparatus of claim 7 wherein the front edge of the cooktop surface member is generally straight and the user interface elements are generally parallel to the front edge.

9. The apparatus of claim 8 wherein the generally circular graphics and their associated generally linear user interface elements are further arranged such that each of the lines bisects a circular graphic and bisects its associated generally linear user interface element.

10. The apparatus of claim 9 wherein no line intersects any other line.

11. The apparatus of claim 10 wherein the lines are essentially perpendicular to the front edge of the cooktop surface member.

12. The apparatus of claim 4 wherein all of the graphics are the same as one another, and all of the user interface elements are the same as one another.

13. The apparatus of claim 12 wherein each of the user interface elements defines a slider bar that is used to select the power level of the heating element with which it is associated.

14. The apparatus of claim 1 wherein the heating elements are inductive elements.

15. An apparatus for a cooking system that comprises a plurality of electrically-operated heating elements that each define a generally circular periphery, and a plurality of heating element power control circuits that each control power flow to a respective one of the heating elements, the apparatus comprising:
a cooktop surface member located above the heating elements and defining a top surface and a front edge; and
a plurality of user interface elements visible from above the top surface of the cooktop surface member and spaced from the heating elements, one of each of the user interface elements operatively associated with a respective one of the heating elements and used to control the heating element power control circuit for such heating element;
wherein the heating elements and the user interface elements are arranged such that for each heating element, two planes that are tangent to the periphery of the heating element and are normal to both the top surface and the front edge of the cooktop surface member fully encompass and do not intersect the user interface element associated with such heating element.

16. The apparatus of claim 15 further comprising an equal plurality of graphics visible from above the top surface of the cooktop surface member, each graphic indicating the location of one of the heating elements.

17. The apparatus of claim 16 wherein the graphics are generally circular.

18. The apparatus of claim 17 wherein the user interface elements are generally linear.

19. The apparatus of claim 18 wherein the user interface elements are located proximate the front edge of the cooktop surface member.

20. The apparatus of claim 19 wherein the front edge of the cooktop surface member is generally straight and the user interface elements are generally parallel to the front edge.

21. The apparatus of claim 20 wherein the generally circular graphics and their associated generally linear user interface elements are further arranged such that straight line segments that run from the center of each circular graphic to the front edge of the cooktop surface member and are normal to the front edge of the cooktop surface member, each bisect a generally linear user interface element.

22. The apparatus of claim 15 wherein the heating elements are inductive elements.

23. An apparatus for a cooking system that comprises a plurality of electrically-operated heating elements that each define a center, and a plurality of heating element power control circuits that each control power flow to one of the heating elements, the apparatus comprising:
a cooktop surface member located above the heating elements and defining a top surface, a front edge, a rear edge, and a bisecting line that is normal to the front edge and the rear edge and divides the cooktop surface member into generally equally sized left and right halves;
a plurality of graphics visible from above the top surface of the cooktop surface member, each graphic defining a center and indicating the location of one of the heating elements; and
a plurality of user interface elements that each define a center, are visible from above the top surface of the cooktop surface member, and are spaced from the heating elements, one of each of the user interface elements operatively associated with a respective one of the heating elements and used to control the heating element power control circuit for such heating element;
wherein the graphics and the user interface elements are arranged such that the angles between straight line segments that run from the center of each graphic to the center of its associated user interface element are symmetric with respect to the cooktop surface member bisecting line.

24. The apparatus of claim 23 wherein the graphics and the user interface elements are arranged such that the angles between adjacent straight line segments are essentially equal.

25. The apparatus of claim 24 wherein the graphics are generally circular.

26. The apparatus of claim 25 wherein the user interface elements are generally linear.

27. The apparatus of claim 26 wherein the user interface elements are located proximate the front edge of the cooktop surface member.

28. The apparatus of claim 27 wherein the front edge of the cooktop surface member is generally straight and the user interface elements are generally parallel to the front edge.

29. The apparatus of claim 23 wherein the heating elements are inductive elements.

30. An apparatus for a cooking system that comprises a plurality of electrically-operated heating elements that each define a center, and a plurality of heating element power control circuits that each control power flow to one of the heating elements, the apparatus comprising:
a cooktop surface member located above the heating elements and defining a top surface and a front edge; and
a plurality of user interface elements that each define a center, are visible from above the top surface of the cooktop surface member, and are spaced from the heating elements, one of each of the user interface elements operatively associated with a respective one of the heating elements and used to control the heating element power control circuit for such heating element;
wherein the heating elements and the user interface elements are arranged such that lines on the top surface of the cooktop surface member that contain both the normal projection of the center of each heating element onto the top surface of the cooktop surface member and the center of its associated user interface element, are all radial with respect to a common point.

31. The apparatus of claim 30 wherein the common point is located on the surface of the cooktop surface member.

32. The apparatus of claim 31 wherein the common point is located along the front edge of the cooktop surface member.

33. The apparatus of claim 32 wherein the common point is located at the center of the front edge of the cooktop surface member.

34. The apparatus of claim 33 further comprising an equal plurality of graphics visible from above the top surface of the cooktop surface member, each graphic indicating the location of one of the heating elements.

35. The apparatus of claim 34 wherein the graphics are generally circular.

36. The apparatus of claim 35 wherein the user interface elements are generally linear.

37. The apparatus of claim 30 wherein the heating elements are inductive elements.
